(19) United States
(12) Patent Application Publication
(10) Pub. No.: US 2020/0203079 A1
(43) Pub. Date: Jun. 25, 2020

(54) CAPACITOR UNIT

(71) Applicant: TDK Corporation, Tokyo (JP)

(72) Inventors: Aiko TAKAHASHI, Tokyo (JP); Daiki ISHII, Tokyo (JP); Shirou OOTSUKI, Tokyo (JP)

(73) Assignee: TDK Corporation, Tokyo (JP)

(21) Appl. No.: 16/716,763

(22) Filed: Dec. 17, 2019

(30) Foreign Application Priority Data
Dec. 21, 2018 (JP) 2018-239183

(51) Int. Cl. H01G 4/38; H01G 4/06; H01G 4/005

(52) U.S. Cl. CPC H01G 4/38; H01G 4/005; H01G 4/06

(57) ABSTRACT

In a capacitor unit including a pair or a plurality of pairs of capacitors having a dielectric, a first electrode formed on the dielectric, and a second electrode formed on the dielectric, wherein voltages in reverse directions are applied between the first electrodes and the second electrodes of respective two capacitors forming a pair.

### TECHNICAL FIELD

The present invention relates to a capacitor unit.

### BACKGROUND

An allowed space for implementing electronic components in an electronic device is decreasing with the electronic device being downsized. Capacitors (each often called a “condenser” in our country) are electronic components mounted on many electronic devices. Therefore, they need to be downsized and reduced in thickness. Thin film capacitors can be more reduced in thickness and profile since their base materials, dielectric layers and insulating films on which dielectrics are formed are thinner than in multi-layered ceramic capacitors by a conventional thick film method. Therefore, thin film capacitors are expected to be electronic components which have low profiles and are implemented in a small space. Furthermore, capacitors which are to be embedded in an electronic component substrate are being developed in recent years.

Many thin film capacitors have had smaller electric capacities than conventional multi-layered ceramic capacitors. One of methods for improving an electric capacity is a method of making the film thickness of a dielectric layer small. However, a smaller film thickness of the dielectric layer causes a larger DC electric field strength even in the case of no change in DC voltage applied in actual use thereof. Therefore, when a ferroelectric such as BaTiO₃ is used, there arises a problem that change in relative dielectric constant due to a DC voltage is large and that an effective electrostatic capacity largely changes (this is hereinafter stated as a DC bias property).

As a method for solving this problem, it is proposed, for example, in Japanese Unexamined Patent Publication No. 2000-49045 to suppress a decrease in dielectric constant due to a DC voltage by using tungsten bronze-type composite oxide containing K, Sr, Mg and Nb for the dielectric layer.

### SUMMARY

It is at issue in recent years that the DC bias property of a capacitor has a polarity. The polarity in DC bias property appears, for example, due to deviation of crystals caused by a production process of the capacitor, the state of the interface between an electrode and a dielectric layer, and/or the like. There arise a problem that operation under implementation is unstable, and a problem of costs and labor caused by need for designating a voltage application direction, due to the polarity in DC bias property.

The present invention is devised in order to solve the aforementioned problems, and an object thereof is to provide a capacitor unit capable of improving a polarity in DC bias property.

An aspect of the present invention is a capacitor unit comprising a pair or a plurality of pairs of capacitors having a dielectric, a first electrode formed on the dielectric, and a second electrode formed on the dielectric, wherein voltages in reverse directions are respectively applied between the first electrodes and the second electrodes of respective two capacitors forming a pair.

According to this configuration, in the capacitor unit including the pair of the plurality of pairs of capacitors having the dielectric, the first electrode formed on the dielectric, and the second electrode formed on the dielectric, the voltages in the reverse directions are respectively applied between the first electrodes and the second electrodes of the respective two capacitors forming the pair. Therefore, polarities in DC bias property of the two capacitors forming the pair are canceled out, and the polarities in DC bias property can be improved.

In this case, the first electrodes and the second electrodes of the respective two capacitors forming the pair out of the capacitors may be connected in such a way as to be respectively in parallel.

According to this configuration, since the first electrodes and the second electrodes of the respective two capacitors forming the pair out of the capacitors are connected in such a way as to be respectively in parallel, a capacity can be increased.

In this case, the plurality of pairs of capacitors may be included, and the first electrodes and the second electrodes of the plurality of respective pairs of capacitors connected in such a way as to be parallel to one another may be connected in such a way as to be respectively in parallel.

According to this configuration, since the plurality of pairs of capacitors are included, and the first electrodes and the second electrodes of the plurality of respective pairs of capacitors connected in such a way as to be parallel to one another are connected in such a way as to be respectively in parallel, a capacity can be further increased.

Moreover, the first electrodes and the second electrodes of the respective two capacitors forming a pair out of the capacitors may be connected in such a way as to be respectively in series.

According to this configuration, since the first electrodes and the second electrodes of the respective two capacitors forming the pair out of the capacitors are connected in such a way as to be respectively in series, reliability can be improved.

According to the capacitor unit of an aspect of the present invention, a polarity in DC bias property can be improved.

### BRIEF DESCRIPTION OF THE DRAWINGS

FIG. 1A is a diagram showing a concept of connection of capacitors of a capacitor unit according to a first embodiment, and FIG. 1B is a diagram schematically showing an actual structure of FIG. 1A;

FIG. 2A is a diagram showing a state where a DC voltage is applied to a capacitor, FIG. 2B is a graph showing a DC bias property in FIG. 2A, FIG. 2C is a diagram showing a state where a DC voltage is applied to a capacitor in the reverse direction to that in FIG. 2A, and

FIG. 2D is a graph showing a DC bias property in FIG. 2C;

FIG. 3 is a diagram showing a concept of improving a polarity in DC bias property in the capacitor unit of the first embodiment;

FIG. 4A is a diagram showing a concept of connection of capacitors of a capacitor unit according to a second embodiment, and

FIG. 4B is a diagram schematically showing an actual structure of FIG. 4A;

FIG. 5A is a diagram showing a concept of connection of capacitors of a capacitor unit according to a third embodiment, and FIG. 5B is a diagram schematically showing an actual structure of FIG. 5A;

FIG. 6A is a diagram showing a concept of connection of capacitors of a capacitor unit according to a fourth embodiment, and FIG. 6B is a diagram schematically showing an actual structure of FIG. 6A;

FIG. 7A is a diagram showing a concept of connection of capacitors of a capacitor unit according to a fifth embodiment, and FIG. 7B is a diagram schematically showing an actual structure of FIG. 7A;

FIG. 8A is a diagram showing a concept of connection of capacitors of a capacitor unit according to a sixth embodiment, and FIG. 8B is a diagram schematically showing an actual structure of FIG. 8A;

FIG. 9A is a diagram showing a concept of connection of capacitors of a capacitor unit according to a seventh embodiment, and FIG. 9B is a diagram schematically showing an actual structure of FIG. 9A;

FIG. 10 is a graph showing a DC bias property of a capacitor unit according to the seventh embodiment in an experimental example;

FIG. 11 is a graph showing a DC bias property of a capacitor unit according to the third embodiment in an experimental example; and

FIG. 12A is a diagram showing a concept of connection of capacitors of a capacitor unit in a comparative example, and FIG. 12B is a graph showing a DC bias property in FIG. 12A.

### DETAILED DESCRIPTION

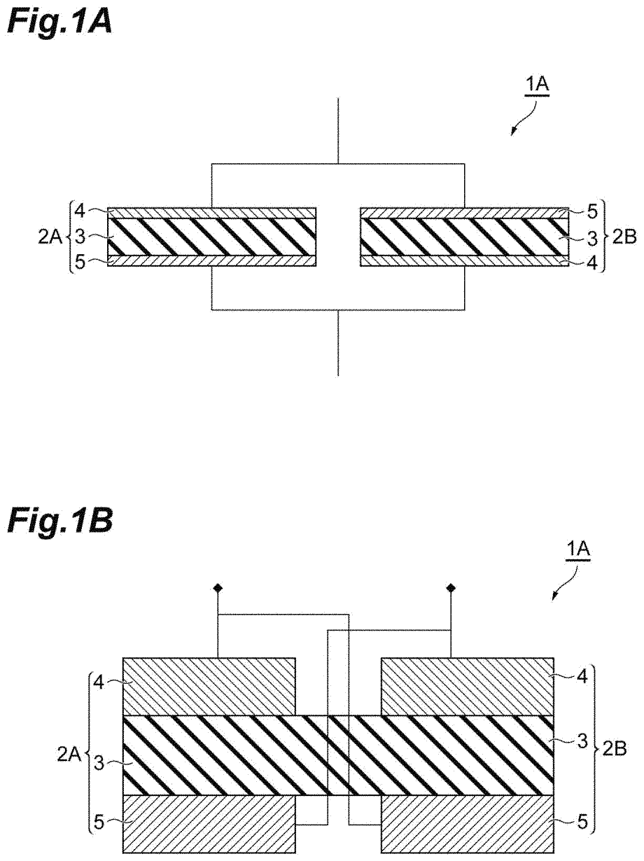

Hereafter, embodiments of the present invention are described in detail using the drawings. As shown in FIG. 1A and FIG. 1B, a capacitor unit 1A of the present embodiment includes a pair or a plurality of pairs of capacitors 2A and 2B having dielectrics 3, first electrodes 4 formed on the dielectrics 3, and second electrodes 5 formed on the dielectrics 3. In the present embodiment, the capacitor unit 1A includes a pair of capacitor 2A and capacitor 2B. The capacitors 2A and 2B are thin film capacitors. The dielectrics 3 are thin film layers containing dielectrics which are, for example, in perovskite crystal structures represented by ABO₃ in which the A element is at least one of Ba, Ca, Sr, Pb and the like and the B element is at least one of Ti, Zr, Sn and the like. The first electrodes 4 and the second electrodes 5 are metal layers, for example, containing metal such as Pt, Ru, Rh, Pd, Ir, Au, Ag, Cu and Ni, alloy of these, or the like.

The structures and the compositions of the capacitors 2A and 2B may be identical. By the structures and the compositions of the capacitors 2A and 2B being identical, the polarity in DC bias property tends to be eliminated. While the structures and the compositions of the capacitors 2A and 2B are not necessarily identical, in the present embodiment, the structures and the compositions of the capacitors 2A and 2B are identical. In the present embodiment, for convenience of description, the capacitor 2A and the capacitor 2B that form a pair are separately called. Nevertheless, as mentioned later, in the capacitor 2A and the capacitor 2B, their DC bias properties when a DC voltage is applied thereto in directions from the first electrodes 4 to the second electrodes 5 are identical. Moreover, in the capacitor 2A and the capacitor 2B, their DC bias properties when a DC voltage is applied thereto in directions from the second electrodes 5 to the first electrodes 4 are identical.

As shown in FIG. 1A, in the present embodiment, the first electrodes 4 and the second electrodes 5 of respective two capacitors 2A and 2B forming a pair out of the capacitors 2A and 2B are connected in such a way as to be respectively in parallel. The first electrodes 4 and the second electrodes 5 of the respective two capacitors 2A and 2B forming the pair are connected in parallel in such a way as to be in reverse directions. Therefore, voltages in the reverse directions are respectively applied between the first electrodes 4 and the second electrodes 5 of the respective two capacitors 2A and 2B forming the pair.

In the capacitor unit 1A of the present embodiment, when a DC voltage is applied to the capacitor 2A, for example, in the direction from the first electrode 4 to the second electrode 5, a DC voltage is applied to the capacitor 2B in the direction from the second electrode 5 to the first electrode 4. Notably, in the following description, it is supposed in principle that a DC voltage is applied to the capacitor 2A in the direction from the first electrode 4 to the second electrode 5 and a DC voltage is applied to the capacitor 2B in the direction from the second electrode 5 to the first electrode 4.

As shown in FIG. 1B, in an actual structure of the capacitor unit 1A, one layer of dielectric 3 serves both as the dielectrics 3 of the respective capacitors 2A and 2B. The first electrodes 4 and the second electrodes 5 of the respective capacitors 2A and 2B are respectively formed, while being divided, on the front and rear surfaces of the one layer of dielectric 3. Nevertheless, with wiring formed on the dielectric 3 through vias or the like, voltages in the reverse directions are respectively applied between the first electrodes 4 and the second electrodes 5 of the respective two capacitors 2A and 2B forming the pair.

In the present embodiment, in the capacitor unit 1A including a pair or a plurality of pairs of capacitors 2A and 2B having the dielectric 3, the first electrodes 4 formed on the dielectric 3, and the second electrodes 5 formed on the dielectric 3, voltages in reverse directions are respectively applied between the first electrodes 4 and the second electrodes 5 of respective two capacitors 2A and 2B forming a pair. Therefore, polarities in DC bias property of the two capacitors 2A and 2B forming the pair are canceled out, and the polarities in DC bias property can be improved.

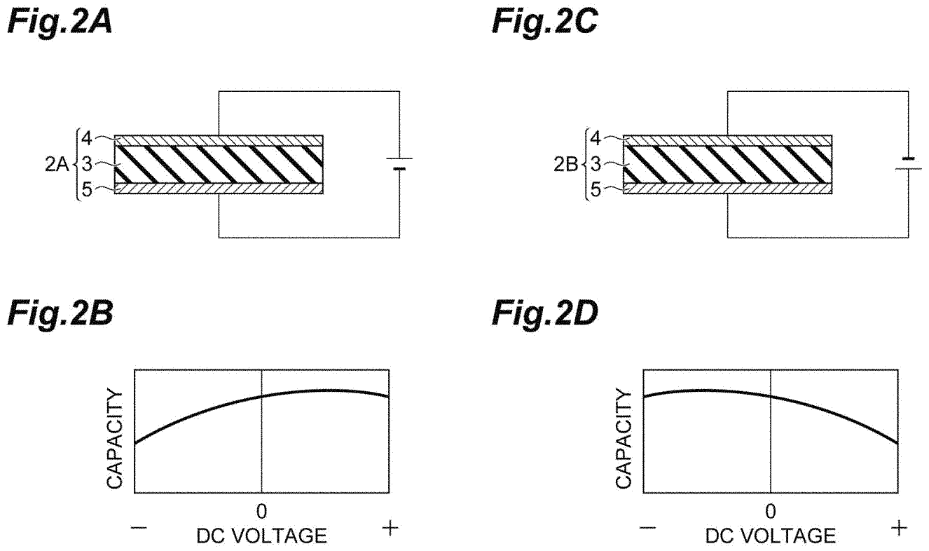

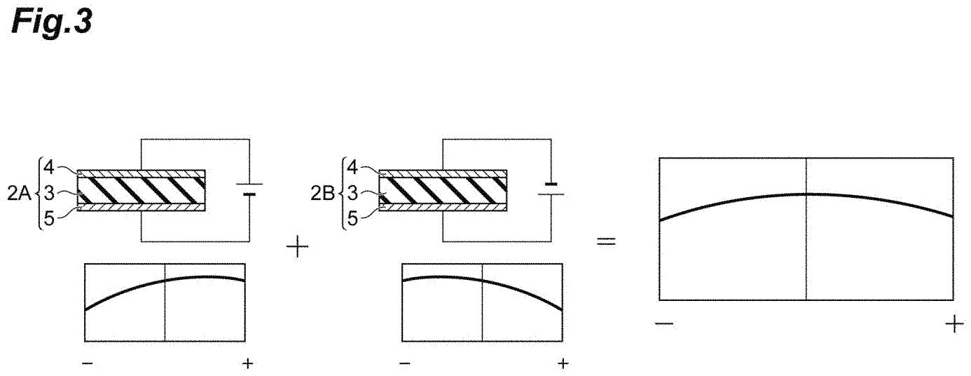

As shown in FIG. 2A, when a DC voltage is applied to the capacitor 2A in the direction from the first electrode 4 to the second electrode 5, a polarity in DC bias property as shown in FIG. 2B appears. Meanwhile, as shown in FIG. 2C, when a DC voltage is applied to the capacitor 2B in the direction from the second electrode 5 to the first electrode 4, a polarity in DC bias property as shown in FIG. 2D appears to be reverse to that in FIG. 2B. Therefore, as shown in FIG. 3, in the present embodiment, voltages in the reverse directions are respectively applied between the first electrodes 4 and the second electrodes 5 of respective two capacitors 2A and 2B forming a pair. Thereby, polarities in DC bias property of two capacitors forming a pair are canceled out, and the polarities in DC bias property can be improved.

Moreover, in the present embodiment, since the first electrodes 4 and the second electrodes 5 of the respective two capacitors 2A and 2B forming the pair out of the capacitors 2A and 2B are connected in such a way as to be respectively in parallel, a capacity can be increased.

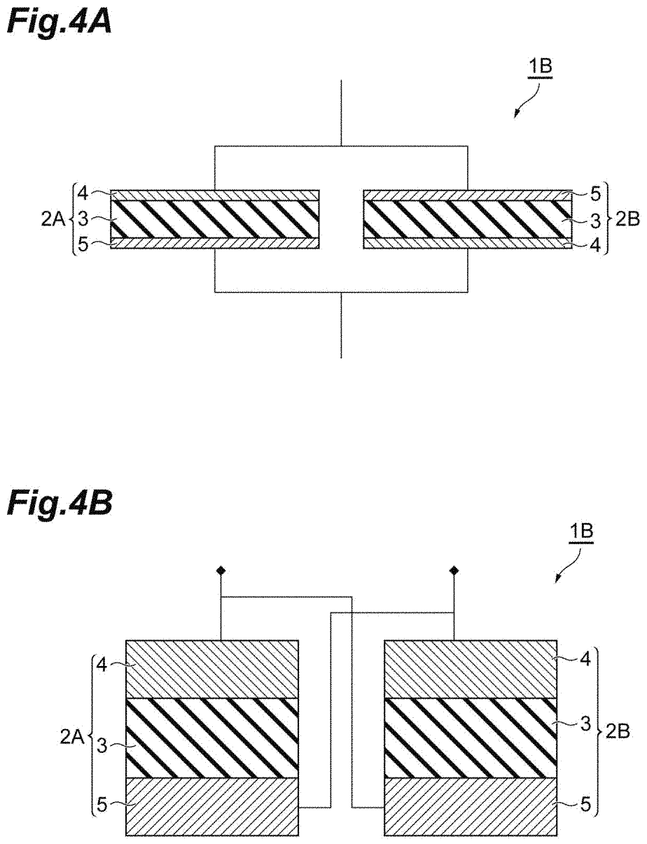

Hereafter, a second embodiment of the present invention is described. As shown in FIG. 4A, the concept of connection of the capacitors 2A and 2B in a capacitor unit 1B of the present embodiment is similar to that for the aforementioned capacitor unit 1A of the first embodiment. As shown in FIG. 4B, in an actual structure of the capacitor unit 1B of the present embodiment, the capacitors 2A and 2B forming a pair have the respective dielectrics 3 which are separate thin films.

The first electrodes 4 and the second electrodes 5 of the respective capacitors 2A and 2B are formed on the front and rear surfaces of the respective dielectrics 3 which are separate thin films. With wiring a part of which passes through the outside of the dielectrics 3, the first electrodes 4 and the second electrodes 5, voltages in reverse directions are respective applied between the first electrodes 4 and the second electrodes 5 of the respective two capacitors 2A and 2B forming the pair. The capacitors 2A and 2B forming a pair may be separately configured as in the present embodiment.

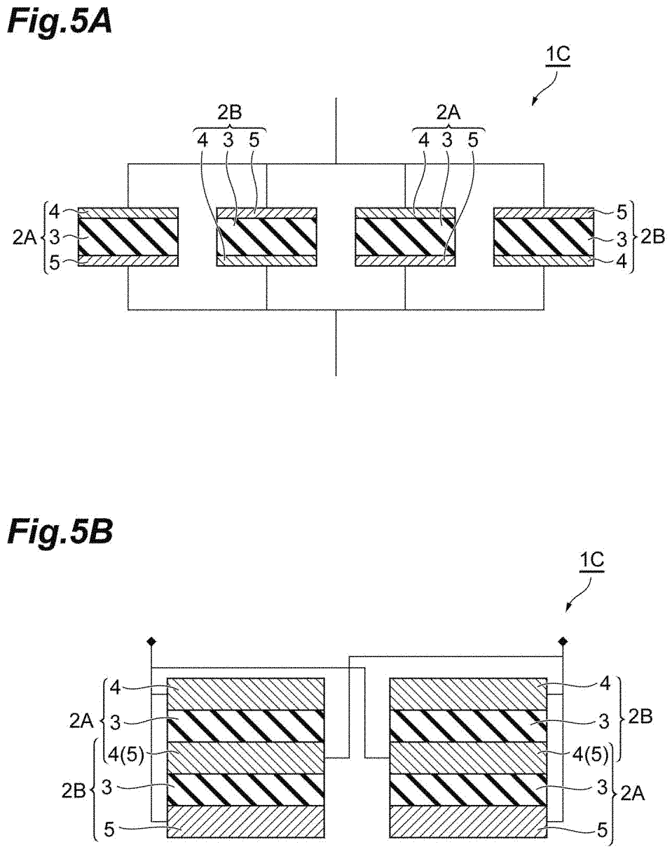

Hereafter, a third embodiment of the present invention is described. As shown in FIG. 5A and FIG. 5B, a capacitor unit 1C of the present embodiment includes a plurality of pairs of capacitors 2A and capacitors 2B. While in the example of FIG. 5A and FIG. 5B, the capacitor unit 1C of the present embodiment includes two pairs of capacitors 2A and capacitors 2B, it may include two or more pairs of capacitors 2A and capacitors 2B.

In the present embodiment, the first electrodes 4 and the second electrodes 5 of respective two capacitors 2A and 2B forming a pair out of the two pairs of capacitors 2A and 2B are connected in such a way as to be respectively in parallel to each other. The first electrodes 4 and the second electrodes 5 of the respective two capacitors 2A and 2B forming the pair out of the two pairs of capacitors 2A and 2B are connected in parallel in such a way as to be in reverse directions.

Moreover, in the present embodiment, the first electrodes 4 and the second electrodes 5 of the respective two pairs of capacitors 2A and 2B connected in such a way as to be parallel to one another are connected in such a way as to be respectively in parallel. Therefore, in the present embodiment, voltages in reverse directions are respectively applied between the first electrodes 4 and the second electrodes 5 of all the respective two capacitors 2A and 2B forming the pairs.

As showing in FIG. 5B, in an actual structure of the capacitor unit 1C of the present embodiment, the capacitor unit 1C includes a pair of stacked bodies in each of which the second electrode 5, the dielectric 3, the first electrode 4 (second electrode 5), the dielectric 3 and the first electrode 4 from the bottom in the figure are sequentially stacked in five layers. The capacitors 2A and the capacitors 2B are respectively formed in both stacked bodies. The third layer from the bottom in the figure in each of the pair of stacked bodies serves both as the first electrode 4 and the second electrode 5 of the capacitor 2A and the capacitor 2B. With wiring passing through the outside of the dielectrics 3, the first electrodes 4 and the second electrodes 5, voltages in reverse directions are respectively applied between the first electrodes 4 and the second electrodes 5 of respective two capacitors 2A and 2B forming a pair.

In the present embodiment, since a plurality of pairs of capacitors 2A and 2B are included, and the first electrodes 4 and the second electrodes 5 of the plurality of respective pairs of capacitors 2A and 2B connected in such a way as to be parallel to one another are connected in such a way as to be respectively in parallel, a capacity can be further increased.

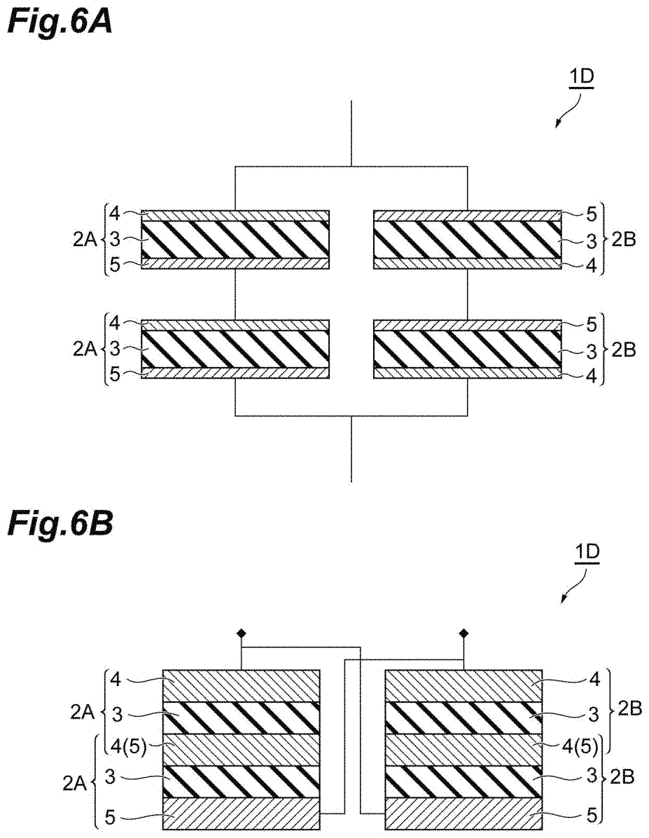

Hereafter, a fourth embodiment of the present invention is described. As shown in FIG. 6A, a capacitor unit 1D of the present embodiment includes two pairs of capacitors 2A and capacitors 2B as shown in FIG. 6A and FIG. 6B. In the present embodiment, the first electrodes 4 and the second electrodes 5 of respective capacitors 2A and 2B forming a pair out of the two pairs of capacitors 2A and 2B are connected in such a way as to be respectively in parallel. The first electrodes 4 and the second electrodes 5 of the respective capacitors 2A and 2B forming the pair out of the two pairs of capacitors 2A and 2B are connected in parallel in such a way as to be in reverse directions.

The capacitor 2A of one pair of the capacitors 2A and 2B connected to be parallel to each other, and the capacitor 2A of the other pair of the capacitors 2A and 2B connected to be parallel to each other are connected in such a way that the first electrodes 4 and the second electrodes 5 of those are respectively in series. The capacitor 2B of one pair of the capacitors 2A and 2B connected to be parallel to each other, and the capacitor 2B of the other pair of the capacitors 2A and 2B connected to be parallel to each other are connected in such a way that the first electrodes 4 and the second electrodes 5 of those are respectively in series. The first electrodes 4 and the second electrodes 5 of respective two capacitors 2A and 2B connected in series are connected in series in such a way as to be in identical directions.

As shown in FIG. 6B, in an actual structure of the capacitor unit 1D of the present embodiment, the capacitor unit 1D includes a pair of stacked bodies in each of which the second electrode 5, the dielectric 3, the first electrode 4 (second electrode 5), the dielectric 3 and the first electrode 4 from the bottom in the figure are sequentially stacked in five layers. The two capacitors 2A are formed in one stacked body, and the two capacitors 2B are formed in the other stacked body. The third layer from the bottom in the figure in the one stacked body serves both as the first electrode 4 and the second electrode 5 of the two capacitors 2A. The third layer from the bottom in the figure in the other stacked body serves both as the first electrode 4 and the second electrode 5 of the two capacitors 2B.

Voltages in reverse directions are respectively applied between the first electrodes 4 and the second electrodes 5 of respective two capacitors 2A and 2B forming a pair and connected in parallel with wiring passing through the outside of the dielectrics 3, the first electrodes 4 and the second electrodes 5. Voltages in identical directions are respectively applied between the first electrodes 4 and the second electrode 5 of the two capacitors 2A and the two capacitors 2B, respectively, connected in series. Notably, in the present embodiment, voltages in the reverse directions may be respectively applied between the first electrodes 4 and the second electrodes 5 of the two capacitors 2A and the two capacitors 2B, respectively, connected in series.

In the present embodiment, since the first electrodes 4 and the second electrodes 5 of respective two capacitors 2A and 2B forming a pair partially out of a plurality of pairs of capacitors 2A and 2B are connected in such a way as to be respectively in parallel, a capacity can be increased.

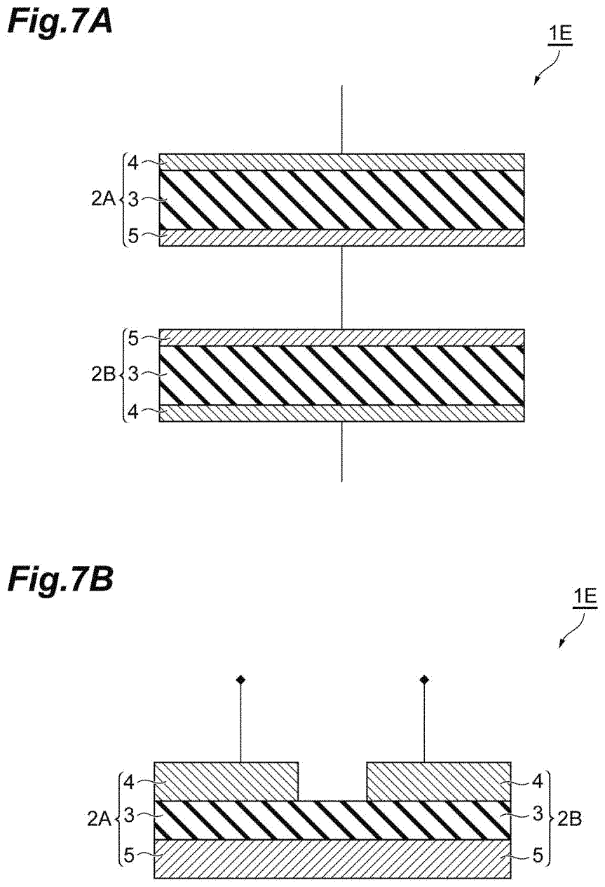

Hereafter, a fifth embodiment of the present invention is described. As shown in FIG. 7A, a capacitor unit 1E of the present embodiment includes a pair of capacitor 2A and capacitor 2B. In the present embodiment, the first electrodes 4 and the second electrodes 5 of the respective two capacitors 2A and 2B forming a pair out of the capacitors 2A and 2B are connected in such a way as to be respectively in series. The first electrodes 4 and the second electrodes 5 of the respective two capacitors 2A and 2B forming the pair out of the pair of capacitors 2A and 2B are connected in series in such a way as to be in reverse directions. Therefore, in the present embodiment, voltages in reverse directions are respectively applied between the first electrodes 4 and the second electrodes 5 of the respective two capacitors 2A and 2B forming the pair.

As shown in FIG. 7B, in an actual structure of the capacitor unit 1E of the present embodiment, the one layer of second electrode 5 and one layer of dielectric 3 serve both as the second electrodes 5 and the dielectrics 3 of the respective capacitors 2A and 2B. The second electrode 5 which is one layer of thin film is formed on the rear surface of the dielectric 3 which is one layer of thin film, the first electrodes 4 divided into two are formed on the front surface of the dielectric 3 which is the one layer of thin film.

In the present embodiment, since the first electrodes 4 and the second electrode 5 of respective two capacitors 2A and 2B forming a pair out of the capacitors 2A and 2B are connected in such a way as to be respectively in series, reliability can be improved.

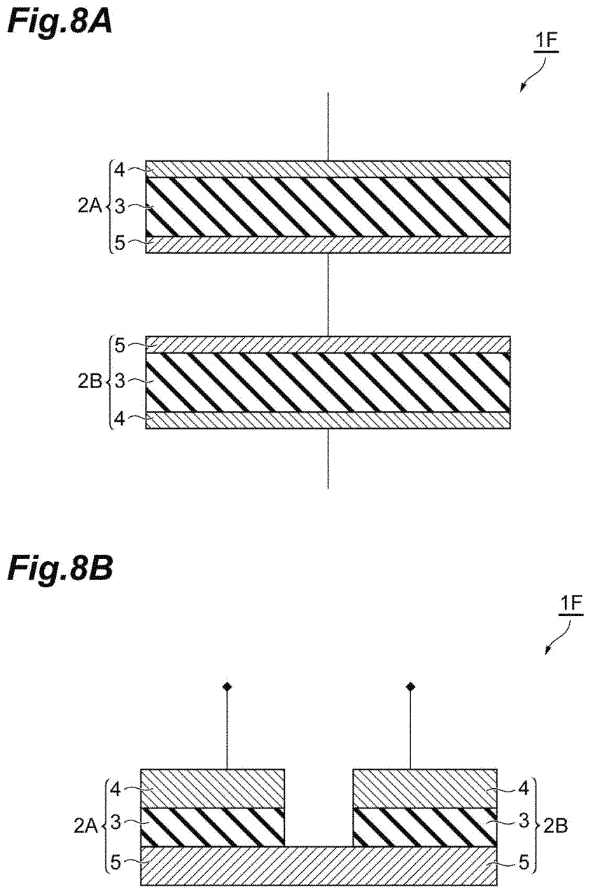

Hereafter, a sixth embodiment of the present invention is described. As shown in FIG. 8A, the concept of connection of the capacitors 2A and 2B in a capacitor unit 1F of the present embodiment is similar to that for the aforementioned capacitor unit 1E of the fifth embodiment. As shown in FIG. 8B, in an actual structure of the capacitor unit 1F of the present embodiment the capacitors 2A and 2B forming a pair have the respective dielectrics 3 which are separate thin films. Similarly to the aforementioned capacitor unit 1E of the fifth embodiment, one layer of second electrode 5 serves both as the second electrodes 5 of the respective capacitors 2A and 2B. As in the present embodiment, the dielectrics 3 of the respective capacitors 2A and 2B forming the pair may be separately configured.

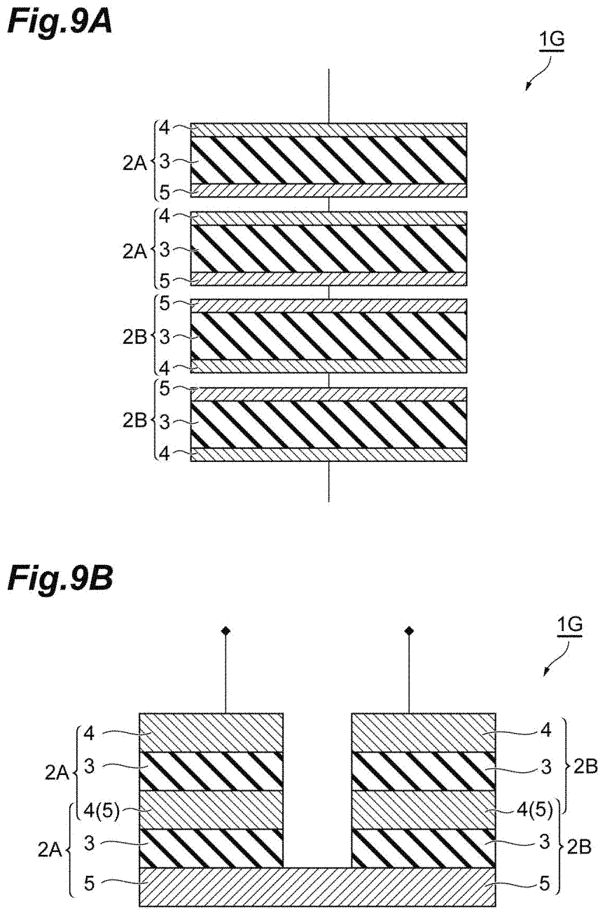

Hereafter, a seventh embodiment of the present invention is described. As shown in FIG. 9A and FIG. 9B, a capacitor unit 1G of the present embodiment includes two pairs of capacitors 2A and capacitors 2B. In the present embodiment, the first electrodes 4 and the second electrodes 5 of respective two capacitors 2A and 2B forming a pair out of the two pairs of capacitors 2A and 2B are connected in such a way as to be respectively in series.

The first electrodes 4 and the second electrodes 5 of the respective two capacitors 2A and 2B forming the pair out of the two pairs of capacitors 2A and 2B are connected in series in such a way as to be in reverse directions. Moreover, in the present embodiment, the first electrodes 4 and the second electrodes 5 of the two pairs of respective capacitors 2A and 2B connected to each other in such a way as to be in series are connected in such a way as to be respectively in series. Therefore, in the present embodiment, voltages in reverse directions are respectively applied between the first electrodes 4 and the second electrodes 5 of all the respective two capacitors 2A and 2B forming the pairs.

As shown in FIG. 9B, in an actual structure of the capacitor unit 1G of the present embodiment, the capacitor unit 1F is a stacked body in which the dielectrics 3, the first electrodes 4 (second electrodes 5), the dielectrics 3 and the first electrodes 4 which are obtained by bisection on the common second electrode 5 from the bottom in the figure are sequentially stacked in five layers. The lowermost layer of the stacked body in the figure serves both as the second electrodes 5 of the capacitor 2A and the capacitor 2B. Moreover, one of the bisected third layers from the bottom in the figure in the stacked body serves both as the first electrode 4 and the second electrode 5 of the two capacitors 2A. The other of the bisected third layers from the bottom in the figure in the stacked body serves both as the first electrode 4 and the second electrode 5 of the two capacitors 2B. With such a configuration, voltages in reverse directions are respectively applied between the first electrodes 4 and the second electrodes 5 of respective two capacitors 2A and 2B forming a pair.

In the present embodiment, since the first electrodes 4 and the second electrodes 5 of all the respective two capacitors 2A and 2B forming the pairs out of the plurality of pairs of capacitors 2A and 2B are connected in such a way as to be respectively in series, reliability can be further improved.

While embodiments of the present invention have been described as above, the present invention is not limited to the aforementioned embodiments but can be implemented in various modes. For example, structures, arrangements and wiring of the dielectrics 3, the first electrodes 4 and the second electrodes 5 of the respective capacitors 2A and 2B can be properly modified as long as voltages in reverse directions are respectively applied between the first electrodes 4 and the second electrodes 5 of respective two capacitors 2A and 2B forming a pair in the capacitor unit 1A, 1B, 1C, 1D, 1E, 1F, 1G mentioned above.

### Experimental Examples

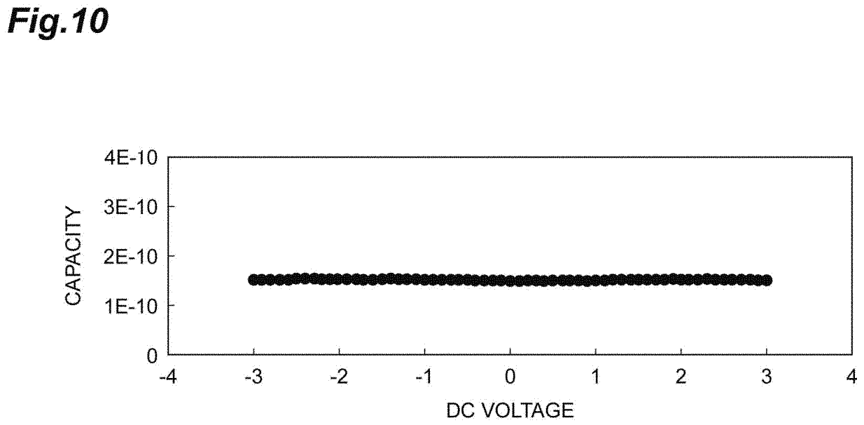

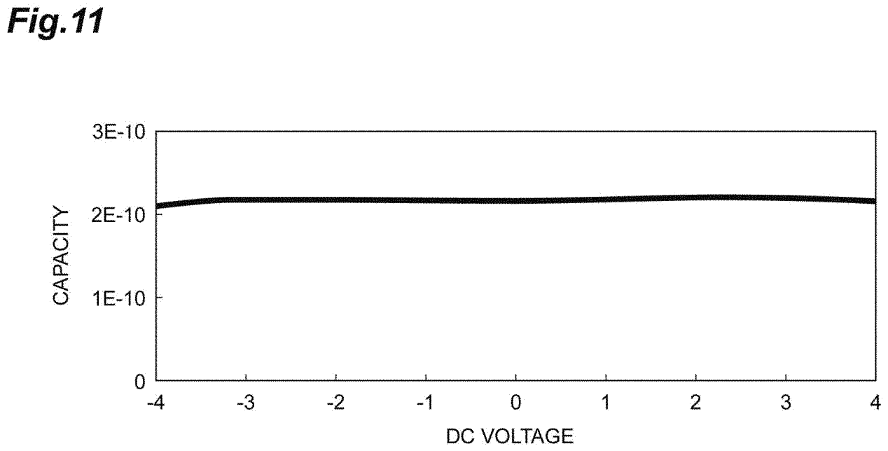

Hereafter, experimental examples of the present invention are described. A DC bias property of the capacitor unit 1G according to the seventh embodiment of the present invention shown in FIG. 9A and FIG. 9B was measured. As shown in FIG. 10, a polarity in bias property was not almost observed for the capacitor unit 1G according to the seventh embodiment. Next, a DC bias property of the capacitor unit 1C according to the third embodiment of the present invention shown in FIG. 5A and FIG. 5B was measured. As shown in FIG. 11, a polarity in bias property was not almost observed for the capacitor unit 1C according to the third embodiment.

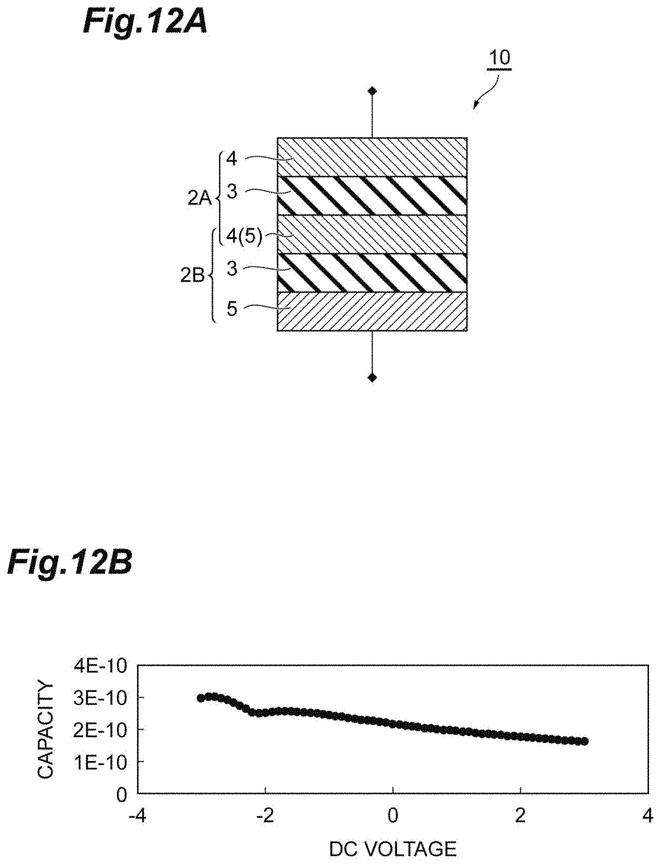

Meanwhile, as a comparative example, a DC bias property of a capacitor unit 10 as shown in FIG. 12A was measured. In the capacitor unit 10, the first electrodes 4 and the second electrodes 5 of all the respective two capacitors 2A and 2B forming the pairs out of a pair of capacitors 2A and 2B are connected in such a way as to be respectively in series. The first electrodes 4 and the second electrodes 5 of respective two capacitors 2A and 2B forming a pair out of the pair of capacitors 2A and 2B are connected in series in such a way as to be in identical directions. Therefore, in the capacitor unit 10, voltages in identical directions are respectively applied between the first electrodes 4 and the second electrodes 5 of the respective two capacitors 2A and 2B forming the pair. As shown in FIG. 12B, a large polarity in bias property was observed for the capacitor unit 10 of the comparative example.

### REFERENCE SIGNS LIST

1A, 1B, 1C, 1D, 1E, 1F, 1G Capacitor unit
2A, 2B Capacitor
3 Dielectric
4 First electrode
5 Second electrode
10 Capacitor unit

What is claimed is:

1. A capacitor unit comprising:
a pair or a plurality of pairs of capacitors having:
a dielectric;
a first electrode formed on the dielectric; and
a second electrode formed on the dielectric:
wherein voltages in reverse directions are respectively applied between the first electrodes and the second electrodes of respective two capacitors forming a pair.

2. The capacitor unit according to claim 1, wherein the first electrodes and the second electrodes of the respective two capacitors forming the pair out of the capacitors are connected in such a way as to be respectively parallel.

3. The capacitor unit according to claim 2, comprising
the plurality of pairs of capacitors,
wherein the first electrodes and the second electrodes of the plurality of respective pairs of capacitors connected in such a way as to be parallel to one another are connected in such a way as to be respectively parallel.

4. The capacitor unit according to claim 1, wherein the first electrodes and the second electrodes of the respective two capacitors forming the pair out of the capacitors are connected in such a way as to be respectively in series.
